(19) United States
(12) Patent Application Publication
(10) Pub. No.: US 2026/0318398 A1
(43) Pub. Date: Oct. 15, 2026

(54) HARMONIC REDUCER UNIT HAVING LOAD MEASURING PART

(71) Applicant: ILJIN GLOBAL HOLDINGS CO., LTD., Seoul (KR)

(72) Inventors: Ji Hun PARK, Seoul (KR); Simon WHITTON, Bad Homburg (DE); Dennis SANDNER, Langgoens (DE)

(73) Assignee: ILJIN GLOBAL HOLDINGS CO., LTD., Seoul (KR)

(21) Appl. No.: 19/482,766

(22) PCT Filed: Dec. 28, 2023
(86) PCT No.: PCT/KR2023/021855

§ 371 Date: Nov. 9, 2025

(30) Foreign Application Priority Data
May 12, 2023 (KR) 10-2023-0061977

(51) Int. Cl. F16H 49/00; G01L 5/00

(52) U.S. Cl. CPC F16H 49/001; G01L 5/0061; F16H 2049/003

(57) ABSTRACT

A harmonic reducer unit having a load measuring part, includes: a wave generator provided with a cam plate having a wave surface; a flex bearing to which the cam plate of the wave generator is fitted and coupled; a flex spline provided outside the flex bearing and having an annular boss; a circular spline provided outside the flex spline and having an inner gear engaging with an outer gear of the flex spline; a first body coupled to the circular spline; and a second body rotatably provided on the first body by means of a support bearing.

### TECHNICAL FIELD

The present invention relates to a harmonic reducer unit, and more particularly to a harmonic reducer unit having a load measuring part.

### BACKGROUND ART

A harmonic reducer is a type of high-precision reducer that performs speed reduction by using a difference in the number of teeth between a flex spline and a circular spline deformed in shape according to the waves generated by a wave generator. As the harmonic reducer is small and lightweight, achieves a high reduction ratio, and has a large transfer torque capacity and a small amount of backlash, the harmonic reducer is used in a field of industrial robots requiring precise reduction ratios.

Generally, the harmonic reducer consists of a wave generator, a flex spline, and a circular spline. The flex spline is deformed by the waves generated by the wave generator and thus performs a harmonic motion so that some of teeth of the flex spline engage with some of teeth of the circular spline. In this case, the number of teeth of the flex spline is slightly different from the number of teeth of the circular spline, and due to such a difference, the harmonic reducer has a high reduction ratio.

FIG. 1 is an exploded perspective view showing a conventional harmonic reducer, and FIG. 2 is a sectional view showing a flex spline.

A conventional harmonic reducer 1 largely includes a circular spline 2, a flex spline 3 located inside the circular spline 2 in such a way as to be concentric to the circular spline 2, and a wave generator 4 having an oval outer peripheral surface in such a way as to be inserted into the flex spline 3.

The circular spline 2 has the shape of a ring and has internal gear teeth 21 on the inner peripheral surface thereof in such a way as to engage with external gear teeth 35 of the flex spline 3.

The flex spline 3 having flexibility consists of a cylindrical body 31, a loop-shaped diaphragm 32 connected to one end of the body 31, a loop-shaped boss 33 formed integrally with the diaphragm 32, and the external gear teeth 35 on the outer peripheral surface of the open end portion of the body 31.

As shown by dotted lines of FIG. 2, the flex spline 3 has a loop-shaped diaphragm 32A extending radially and outwardly from the body 31. Further, a loop-shaped boss 33A extends from the outer periphery of the diaphragm 32A in such a way as to be formed integrally with the diaphragm 32A.

The wave generator 4 includes a cam plate 41 having an oval wave surface and a wave bearing 42 fittedly coupled to the outer peripheral surface of the cam plate 41.

The wave bearing 42 consists of an inner race 42a, an outer race 42b, and a plurality of balls 42c as rolling elements arranged rollably between the inner race 42a and the outer race 42b. The inner race 42a and the outer race 42b are flexible.

FIG. 3 is a sectional view showing a conventional harmonic reducer unit.

As shown in FIG. 3, a conventional harmonic reducer unit includes a ring-shaped first body 5 coupled to the circular spline 2 and a ring-shaped second body 6 rotatably coupled to the first body 5 by means of a support bearing 7.

The boss 33 of the flex spline 3 is coupled to the second body 6 by means of a plurality of second coupling bolts 18. The plurality of second coupling bolts 18 are spaced apart from one another in a circumferential direction in such a way as to allow the boss 33 to be fastened to the second body 6.

The first body 5 is coupled to the circular spline 2 by means of a plurality of first coupling bolts 19. The plurality of first coupling bolts 19 are spaced apart from one another in a circumferential direction of the circular spline 2 to allow the first body 5 to be fastened to the circular spline 2.

In FIG. 3, a reference numeral 17 indicates a first cover coupled to the circular spline 2 by means of the fastening of the first coupling bolts 19, and a reference numeral 8 indicates a second cover coupled to the second body 6 by means of the fastening of the second coupling bolts 18. The plurality of second coupling bolts 18 are spaced apart from one another in the circumferential direction of the boss 33 in such a way as to allow the boss 33 to be fastened to the second body 6.

Further, reference numerals 13, 14, and 15 indicate seals, 12 and 16 O-rings, and 9 and 11 generator bearings for rotatably supporting the wave generator 4 with respect to the first cover 17 and the second cover 8 on both sides thereof.

If the conventional harmonic reducer unit is mounted and thus used on a robot or the like, it may fail to measure an external force applied thereto. To measure the external force applied to the harmonic reducer unit, an electric current of a motor rotating the wave generator 4 is measured and converted into a load torque, and otherwise, the twist of an available part that is generated during rotations is measured. However, the conventional harmonic reducer unit fails to measure loads, particularly bending moments or impacts, except for rotational directions, so that it is impossible to operate the robot according to the measured loads.

If a harmonic reducer unit is mounted on a robot to lift up and transfer an object, for example, the object with a heavy weight is lifted up at a relatively low speed, and the object with a light weight is lifted up at a relatively high speed. However, the conventional harmonic reducer unit does not measure bending moments applied thereto that are generated from the load of the object, thereby failing to control the robot's operations corresponding to the load of the object.

### DISCLOSURE OF THE INVENTION

### Technical Problems

Accordingly, to solve the above-mentioned problems occurring in the related art, it is an object of the present invention to provide a harmonic reducer unit having a load measuring part that is capable of measuring loads except for rotational directions, such as bending moments or impacts, through the load measuring part.

### Technical Solutions

To accomplish the above-mentioned objects, according to the present invention, a harmonic reducer unit may include: a wave generator provided with a cam plate having a wave surface; a flex bearing to which the cam plate of the wave generator is fitted and coupled; a flex spline provided outside the flex bearing and having an annular boss; a circular spline provided outside the flex spline and having internal gear teeth engaging with external gear teeth of the flex spline; a first body coupled to the circular spline; and a second body rotatably provided on the first body by means of a support bearing.

The harmonic reducer unit may further include: a plurality of second coupling bolts for coupling the boss to the second body; and a load measuring part coupled to the boss and the second body by means of the second coupling bolts thereto and having ring-shaped load detection sensors adapted to pass the second coupling bolts therethrough in such a way as to allow the boss and the second body to be fastened by the second coupling bolts.

In the above, at least three load detection sensors may be located on the fastening positions of the second coupling bolts in such a way as to be spaced apart from one another in a circumferential direction.

In the above, the load measuring part may include a ring-shaped measuring part body having a plurality of bolt holes in the circumferential direction thereof, and the load detection sensors may be located on the positions where the bolt holes of the measuring part body are formed.

In the above, the measuring part body may include an amplifier for amplifying the signals outputted from the load detection sensors, a body controller for converting the amplified signals into load signals, and a transmitter for transmitting the converted load signals.

In the above, at least three load detection sensors may be provided on the load measuring part, and an angle between the axial centers of the neighboring two load detection sensors, as the opposite angle to the remaining load detection sensor, may be smaller than 180°.

In the above, the load measuring part may have a sealing portion extending circumferentially from at least one surface of the measuring part body in an axial direction of the measuring part body in such a way as to protrude axially from the measuring part body.

In the above, sealing portions may be formed on both side surfaces of the measuring part body in the axial direction of the measuring part body.

In the above, the sealing portions may be located on the insides and outsides of the bolt holes.

In the above, the load measuring part may have a plurality of sealing connectors spaced apart from one another in the circumferential direction of the measuring part body in such a way as to be connected to the sealing portions located on the insides and outsides of the bolt holes.

### Advantageous Effects of the Invention

According to the present invention, if the harmonic reducer unit that is provided with the load measuring part is mounted and used on a robot or the like, external forces, such as bending moments or impacts, applied to the harmonic reducer unit can be measured through the load measuring part, thereby controlling the operations of the robot according to the measured loads.

### BRIEF DESCRIPTION OF DRAWINGS

FIG. 1 is an exploded perspective view showing a conventional harmonic reducer.

FIG. 2 is a sectional view showing a flex spline of a conventional harmonic reducer.

FIG. 3 is a sectional view showing a conventional harmonic reducer unit.

FIG. 4 is a sectional view showing a harmonic reducer unit having a load measuring part according to the present invention.

FIGS. 5 to 7 are plan views showing the load measuring part of the harmonic reducer unit according to the present invention.

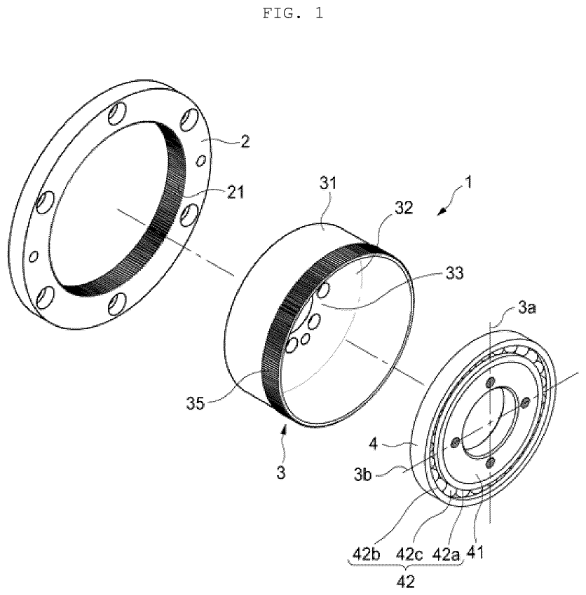

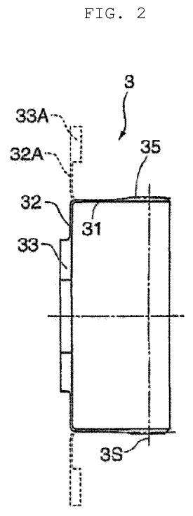

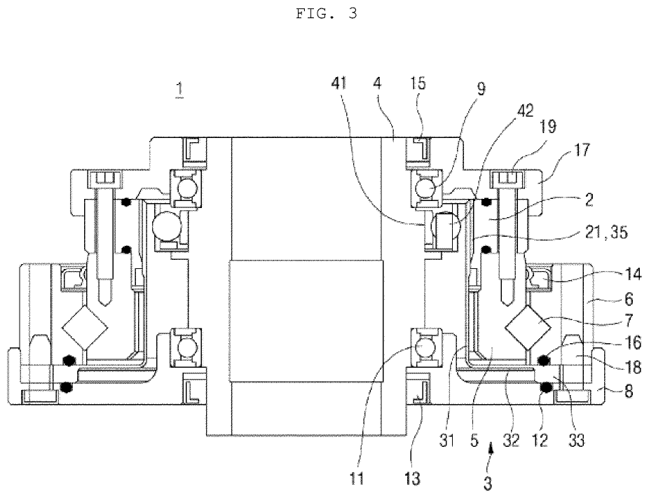

### MODE FOR INVENTION

All terms used herein, including technical or scientific terms, unless otherwise defined, have the same meanings which are typically understood by those having ordinary skill in the art. The terms, such as ones defined in common dictionaries, should be interpreted as having the same meanings as terms in the context of pertinent technology, and should not be interpreted as having ideal or excessively formal meanings unless clearly defined in the specification.

The terms “having,” “including,” “containing” and similar referents in the specification are to be construed as open-ended terms meaning “including, but not limited to,” unless otherwise noted.

An expression referencing a singular value additionally refers to a corresponding expression of the plural number, unless explicitly limited otherwise by the context.

Terms, such as “the first”, “the second”, and the like may be used to describe various elements, but the elements should not be restricted by the terms. The terms are used to only distinguish one element from the other element.

When it is said that one element is described as being “connected” or “coupled” to the other element, one element may be directly connected or coupled to the other element, but it should be understood that another element may be present between the two elements. In contrast, when it is said that one element is described as being “directly connected” or “directly coupled” to the other element, it should be understood that another element is not present between the two elements.

Hereinafter, an explanation of a harmonic reducer unit having a load measuring part according to the present invention will be given with reference to the attached drawings. A repeated explanation of the harmonic reducer unit having a load measuring part according to the present invention with the conventional technology will be avoided.

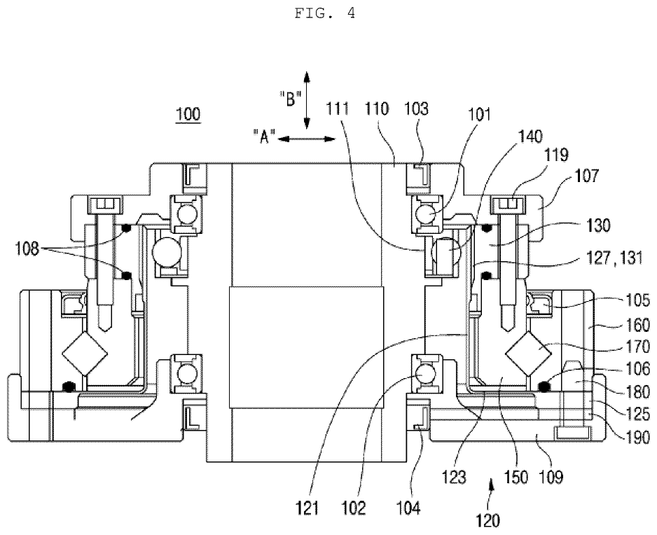

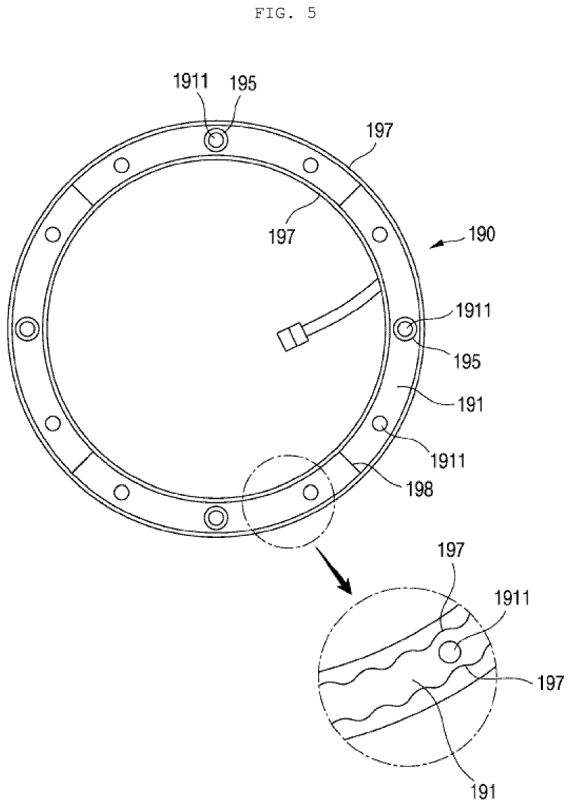

FIG. 4 is a sectional view showing a harmonic reducer unit having a load measuring part according to the present invention, and FIGS. 5 to 7 are plan views showing the load measuring part of the harmonic reducer unit according to the present invention.

In the description, a vertical direction B of FIG. 4 means an axial direction, and a rotational center of a wave generator 110 as will be discussed later is a center of an axis.

As shown in FIG. 4, a harmonic reducer unit 100 according to the present invention includes a wave generator 110, a flex bearing 140, a flex spline 120, a circular spline 130, a first body 150, a second body 160, and a load measuring part 190.

The wave generator 110 is a cylindrical hollow body. The wave generator 110 is provided with a cam plate 111 that is disposed on the axial central portion thereof and has an oval wave surface. The flex bearing 140 is fittedly coupled to the outer peripheral surface of the cam plate 111.

The flex bearing 140 is concentric to the wave generator 110 and provided outside the wave generator 110. The flex bearing 140 inserts the wave generator 110 thereinto. The cam plate 111 of the wave generator 110 is fittedly coupled to the flex bearing 140. The flex bearing 140 consists of an inner race, an outer race, and a plurality of balls as rolling elements rotatably arranged between the inner race and the outer race, and the inner race and the outer race are flexible.

The flex spline 120 is concentric to the flex bearing 140 and located outside the flex bearing 140. The flex spline 120 is flexible.

The flex spline 120 includes a cylindrical body 121, an annular diaphragm 123 extending radially and outwardly from one side of the body 121 in an axial direction of the body 121, an annular boss 125 disposed along the outer periphery of the diaphragm 123, and external gear teeth 127 on the outer peripheral surface of the other side of the body 121 in the axial direction of the body 121. The boss 125 is higher in thickness than the diaphragm 123.

The diaphragm 123 of the flex spline 120 extends radially and inwardly from the body 121, and the boss 125 has the shape of a loop extending from the inner periphery of the diaphragm 123 in a radial direction of the diaphragm 123.

The circular spline 130 is concentric to the flex spline 120 and provided outside the flex spline 120. The circular spline 130 has the shape of a ring. The circular spline 130 has internal gear teeth 131 on the inner peripheral surface thereof in such a way as to engage with the external gear teeth 127 of the flex spline 120.

The first body 150 has the shape of a ring. The first body 150 is located between the circular spline 130 and the diaphragm 123 of the flex spline 120. The first body 150 is coupled to the circular spline 130 by means of a plurality of first coupling bolts 119. The plurality of first coupling bolts 119 are spaced apart from one another in a circumferential direction of the circular spline 130 in such a way as to allow the first body 150 to be fastened to the circular spline 130.

The second body 160 has the shape of a ring. The second body 160 is located outside the first body 150. The second body 160 is rotatably coupled to the first body 150 by means of a support bearing 170. The boss 125 of the flex spline 120 is coupled to the second body 160 by means of a plurality of second coupling bolts 180. The plurality of second coupling bolts 180 are spaced apart from one another in a circumferential direction of the boss 125 in such a way as to allow the second body 160 to be fastened to the boss 125.

According to the present invention, the harmonic reducer unit 100 is configured to allow the flex spline 120 to serve as an output shaft or to allow the circular spline 130 to serve as an output shaft according to installation thereof.

In FIG. 4, a reference numeral 107 indicates a first cover coupled to the circular spline 130 by means of the fastening of the first coupling bolts 119, and a reference numeral 109 indicates a second cover coupled to the second body 160 by means of the fastening of the second coupling bolts 180.

Further, reference numerals 103, 104, and 105 indicate seals, 106 and 108 O-rings, and 101 and 102 generator bearings for rotatably supporting the wave generator 110 with respect to the first cover 107 and the second cover 109 on both sides thereof.

The load measuring part 190 has the shape of a ring. The load measuring part 190 is located between the boss 125 and the second cover 109. The load measuring part 190 has bolt holes 1911 so that it is coupled to the boss 125, the second cover 109, and the second body 160 by means of the second coupling bolts 180.

As shown in FIG. 5, the load measuring part 190 includes a measuring part body 191, sealing portions 197, and a plurality of load detection sensors 195.

The measuring part body 191 has the shape of a ring. The measuring part body 191 has the plurality of bolt holes 1911 in a circumferential direction thereof.

The measuring part body 191 is divided into three or more arches that are spaced apart from one another in the circumferential direction thereof. The measuring part body 191, which is divided into the three or more arches, has the plurality of bolt holes 1911 in extending directions of the arches.

For example, the measuring part body 191 is a PCB, and the measuring part body 191 is provided with an amplifier for amplifying the signals outputted from the load detection sensors 195, a body controller for converting the amplified signals into load signals, and a transmitter for transmitting the converted load signals.

The sealing portion 197 is made of rubber. The sealing portion 197 extends circumferentially from at least one surface of the measuring part body 191 in the axial direction of the measuring part body 191 in such a way as to protrude axially from the measuring part body 191. Desirably, sealing portions 197 are formed on both side surfaces of the measuring part body 191 in the axial direction of the measuring part body 191.

Each sealing portion 197 has the shape of a ring extending circumferentially. The sealing portions 197 are located on the insides and outsides of the bolt holes 1911. The sealing portions 197 are spaced apart from each other in a radial direction of the measuring part body 191, thereby enhancing sealing and buffering effectiveness.

As shown in an enlarged circle of FIG. 5, the sealing portions 197 extend circumferentially from the measuring part body 191 in such a way as to be curved outward from the measuring part body 191 within the radial direction of the measuring part body 191 or be formed in a zigzag pattern. If the sealing portions 197 are curvedly formed, they increase in area so that they have bigger buffering effectiveness than linear sealing portions and are compressedly sealed with loads greater than loads the linear sealing portions have.

As the sealing portions 197 are provided, they prevent an internal lubricant from leaking to the outside or prevent external foreign substances from entering, which needs no separate O-rings, and further, they ensure reliable sealing effectiveness. Furthermore, the sealing portions 197 perform buffering functions to prevent the measuring part body 191 from being brought into direct contact with the boss 125 and the second cover 109 and thus pressurized thereagainst, which protects the measuring part body 191 from a damage or breakdown.

A plurality of sealing connectors 198 are located between the sealing portions 197 spaced apart from each other on both sides of the measuring part body 191 in the radial direction of the measuring part body 191.

The plurality of sealing connectors 198 are spaced apart from one another in the circumferential direction of the measuring part body 191 in such a way as to be connected to the sealing portions 197 located on the insides and outsides of the bolt holes 1911. Each sealing connector 198 is disposed between the neighboring bolt holes 1911. If the measuring part body 191 is divided into the three or more arches, further, each sealing connector 198 is located between the end portions of the neighboring arches.

As the sealing connectors 198 are provided, they serve as support rods for supporting the sealing portions 197 to prevent the lubricant or foreign substances from leaking or being invaded from the outside, thereby achieving high sealing effectiveness.

The plurality of load detection sensors 195 are provided. Each load detection sensor 195 has the shape of a ring. For example, the load detection sensors 195 are piezoelectric sensors. The load detection sensors 195 are located on the positions where the bolt holes 1911 of the measuring part body 191 are formed. If the measuring part body 191 is constituted of the three or more arches, the load detection sensors 195 are located on the respective arches.

The load detection sensors 195 are located between the second cover 109 and the measuring part body 191 or between the boss 125 and the measuring part body 191 on the positions where the bolt holes 1911 are formed.

The load detection sensors 195 are spaced apart from one another in the circumferential direction of the measuring part body 191 in such a way as to be located on the fastening positions of the second coupling bolts 180. At least three or more load detection sensors 195 are provided. The load detection sensors 195 to which the second coupling bolts 180 are fastened are fixedly pressed against the second coupling bolts 180.

If a load in a direction of an arrow “B” is applied to the harmonic reducer unit 100 having the load measuring part in a state where the load detection sensors 195 are pressed against the second coupling bolts 180, the load is sensed by the load detection sensors 195. The loads measured through the load detection sensors 195 are calculated by the following expression.

$${F}_{θ} = \frac{{F}_{a}}{{n}_{bolt}} + \frac{4.37 \times {M}_{tilt}}{{d}_{PCD} \times {n}_{bolt}} \times {COS}^{2.1} θ$$

(wherein F_{θ} is a load applied to each second coupling bolt 180,
θ is a position of each second coupling bolt 180 in the circumferential direction,
d_{PCD} is a pitch circle diameter of the support bearing 170,
n_{bolt} is the number of second coupling bolts 180,
Fₐ is an axial external force applied to the circular spline 130 or the second body 160, and
Mₜᵢₗₜ is a bending moment applied to the second body 160 by means of the load applied in the direction of “A”).

As there are three variables (Fₐ, Mₜᵢₗₜ, and θ) in the above expression, at least three or more load detection sensors 195 are provided, so that the sensed values through the load detection sensors 195 are inputted and calculated, and desirably, four load detection sensors 195 are provided to further perform an error test.

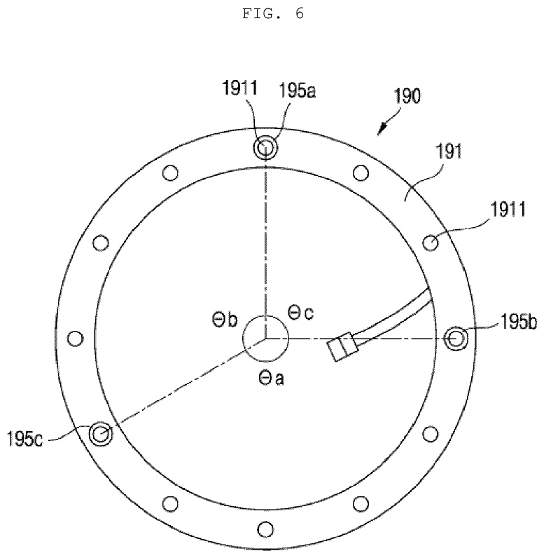

FIG. 6 is a sectional view showing the load measuring part 190 with three load detection sensors 195.

As shown in FIG. 6, an angle θb between the axial centers of the neighboring load detection sensors 195a and 195c, as the opposite angle to the remaining load detection sensor 195b, is smaller than 180°, an angle θc between the axial centers of the neighboring load detection sensors 195a and 195b, as the opposite angle to the remaining load detection sensor 195c, is smaller than 180°, and an angle Ga between the axial centers of the neighboring load detection sensors 195b and 195c, as the opposite angle to the remaining load detection sensor 195a, is smaller than 180°.

If the angle between the axial centers of the neighboring load detection sensors 195, as the opposite angle to the remaining load detection sensor 195, is greater than 180°, an area measured becomes small so that the loads applied to the second coupling bolts 180 may not be accurately calculated.

It is therefore desirable that the angle between the axial centers of the neighboring load detection sensors 195, as the opposite angle to the remaining load detection sensor 195, should be smaller than 180°.

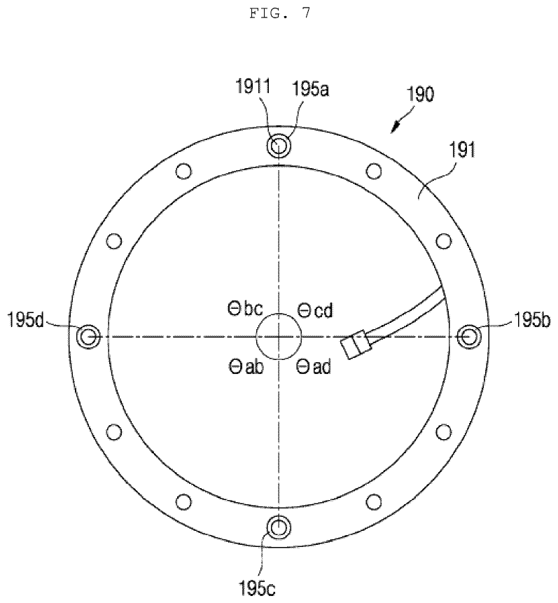

As shown in FIG. 7, it is more desirable that four load detection sensors 195 should be provided to further perform an error test.

If the four load detection sensors 195 are provided, an angle θbc between the axial centers of the neighboring load detection sensors 195a and 195d, as the opposite angle to an angle between the remaining load detection sensors 195b and 195c, is smaller than 180°, an angle θab between the axial centers of the neighboring load detection sensors 195d and 195c, as the opposite angle to an angle between the remaining load detection sensors 195a and 195b, is smaller than 180°, an angle Gad between the axial centers of the neighboring load detection sensors 195b and 195c, as the opposite angle to an angle between the remaining load detection sensors 195a and 195d, is smaller than 180°, and an angle Gab between the axial centers of the neighboring load detection sensors 195a and 195b, as the opposite angle to an angle between the remaining load detection sensors 195c and 195d, is smaller than 180°.

As mentioned above, the harmonic reducer unit 100 is provided with at least three or more load detection sensors 195 so that as the load detection sensors 195 are pressed against the second coupling bolts 180, external forces such as bending moments or impacts applied to the harmonic reducer unit 100 can be measured through the load detection sensors 195, thereby controlling operations of a robot or the like.

### INDUSTRIAL APPLICABILITY

If the harmonic reducer unit that is provided with the load measuring part is mounted and used on a robot and the like, external forces such as bending moments or impacts applied to the harmonic reducer unit can be measured through the load measuring part, so that if an object is lifted up by the robot, the bending moments or impacts applied to the harmonic reducer unit that are generated due to the load of the object are measured through the load measuring part, thereby controlling the operations of the robot according to the weight of the object.

1. A harmonic reducer unit comprising: a wave generator (110) provided with a cam plate (111) having a wave surface; a flex bearing (140) to which the cam plate (111) of the wave generator (110) is fitted and coupled; a flex spline (120) provided outside the flex bearing (140) and having an annular boss (125); a circular spline (130) provided outside the flex spline (120) and having internal gear teeth (131) engaging with external gear teeth (127) of the flex spline (120); a first body (150) coupled to the circular spline (130); a second body (160) rotatably provided on the first body (150) by means of a support bearing (170); a plurality of second coupling bolts (180) for coupling the boss (125) to the second body (160); and a load measuring part (190) coupled to the boss (125) and the second body (160) by means of the second coupling bolts (180) and having ring-shaped load detection sensors (195) adapted to pass the second coupling bolts (180) therethrough in such a way as to allow the boss (125) and the second body (160) to be fastened by the second coupling bolts (180).

2. The harmonic reducer unit according to claim 1, wherein at least three load detection sensors (195) are located on the fastening positions of the second coupling bolts (180) in such a way as to be spaced apart from one another in a circumferential direction.

3. The harmonic reducer unit according to claim 2, wherein the load measuring part (190) comprises a ring-shaped measuring part body (191) having a plurality of bolt holes (1911) in the circumferential direction thereof, and the load detection sensors (195) are located on the positions where the bolt holes (1911) of the measuring part body (191) are formed.

4. The harmonic reducer unit according to claim 3, wherein the measuring part body (191) comprises an amplifier for amplifying the signals outputted from the load detection sensors (195), a body controller for converting the amplified signals into load signals, and a transmitter for transmitting the converted load signals.

5. The harmonic reducer unit according to claim 2, wherein at least three load detection sensors (195) are provided on the load measuring part (190), and an angle between the axial centers of the neighboring two load detection sensors (195), as the opposite angle to the remaining load detection sensor (195), is smaller than 180°.

6. The harmonic reducer unit according to claim 3, wherein the load measuring part (190) has a sealing portion (197) extending circumferentially from at least one surface of the measuring part body (191) in an axial direction of the measuring part body (191) in such a way as to protrude axially from the measuring part body (191).

7. The harmonic reducer unit according to claim 6, wherein sealing portions (197) are formed on both side surfaces of the measuring part body (191) in the axial direction of the measuring part body (191).

8. The harmonic reducer unit according to claim 6, wherein the sealing portions (197) are located on the insides and outsides of the bolt holes (1911).

9. The harmonic reducer unit according to claim 8, wherein the load measuring part (190) has a plurality of sealing connectors (198) spaced apart from one another in the circumferential direction of the measuring part body (191) in such a way as to be connected to the sealing portions (197) located on the insides and outsides of the bolt holes (1911).
